(19) United States
(12) Patent Application Publication
(10) Pub. No.: US 2005/0006884 A1
(43) Pub. Date: Jan. 13, 2005

(54) Occupant safety protection system

(75) Inventors: John Cooper, Oxford, MI (US); Kaustubh Bedekar, Auburn Hills, MI (US); Gerald T. McHale, Troy, MI (US); Robert L. Arwood, Fraser, MI (US); Eric J. Baumbach, Sterling Heights, MI (US); Robert H. Block, Clarkston, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: Key Safety Systems, Inc.

(21) Appl. No.: 10/674,257

(22) Filed: Sep. 29, 2003

Related U.S. Application Data
(60) Provisional application No. 60/453,433, filed on Mar. 10, 2003.

(51) Int. Cl. B60R 21/32

(52) U.S. Cl. 280/735

(57) ABSTRACT

An occupant safety restraint system comprising: a first occupant protection system having at least one seat belt movable about the occupant: a second occupant protection system comprising a deployable knee bolster to protect at least a portion of the lower extremities of the occupant and a switch mechanism or sensor for deactivating the second occupant protection system based upon the operational state of the first occupant protection system.

### BACKGROUND AND SUMMARY OF THE INVENTION

This application is related to and claims priority from provisional application Ser. No. 60/453,433, filed Mar. 10, 2003.

The present invention generally relates to vehicular occupant protection systems and more particularly to such a system which includes a seat belt system with a cooperating knee bolster as well as a means for deactivating the knee bolster based upon certain system parameters.

It is an object of the present invention to provide an occupant restraint system having improved performance.

Accordingly the invention comprises: an occupant safety restraint system comprising: a first occupant protection system having at least one seat belt movable or latchable about an occupant, a second occupant protection system comprising a deployable knee bolster to protect at least a portion of the lower extremities of the occupant and first means for deactivating the second occupant protection system based upon the operational state of the first occupant protection system.

Many other objects and purposes of the invention will be clear from the following detailed description of the drawings.

### BRIEF DESCRIPTION OF THE DRAWINGS

FIG. 1 shows an exemplary seat belt safety system.

FIG. 2 shows a lower leg protection system.

### DETAILED DESCRIPTION OF THE DRAWINGS

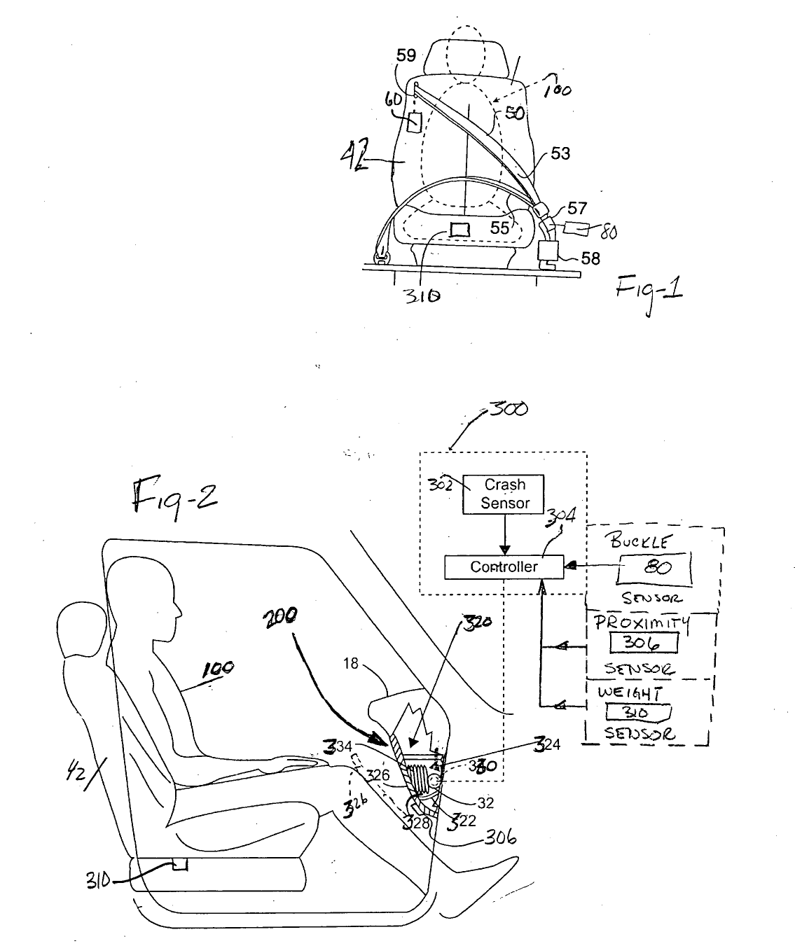

Reference is made to FIGS. 1 and 2, which illustrate a seat belt system 50 and a lower leg protection system 200, each of which is designed to protect a seated occupant 100 who may be a driver or passenger. The safety belt system 50 comprises an optional shoulder belt 53, lap belt 55, tongue 57 and buckle 58, which are appropriately anchored to the vehicle floor or vehicle seat. While the shoulder belt 53 is shown emanating from an opening 59 in the seat, the seat belt system 50 can be configured with the shoulder belt looped through a D-ring (or web guide) and secured to the B-pillar (or C-pillar for seat 42) of the vehicle. The shoulder belt is maintained about the occupant. The seat belt restraint system 50 may also include a seat belt retractor 60 of known variety mounted in the seat back, in the seat frame, or adjacent the B or C-pillar, as the case may be. While a three-point seat belt system is shown in FIG. 1, the use of other configurations including a two-point system, that is, a system without the shoulder belt or a four-point system, that is, one with two shoulder belts are within the scope of the present invention.

As is known in the art, the buckle includes a movable latch (not shown), which enters into a cooperating opening in the tongue. The buckle 58 can include a latch sensor 80, which generates an output signal to indicate the occupant 100 has buckled the seat belt about him or herself. One such latch sensor may include a Hall effect sensor located within the buckle and configured to generate an output signal after the buckle latch has moved into locking engagement with the tongue. This type of latch sensor includes a permanent magnet located in the buckle or tongue, with the relative motion between the Hall effect sensor and the magnet causing a change in the output signal of the sensor. Other types of sensors can be used such as a seat belt tensor sensor, which generates a signal indicative of the tension in the lap belt. The existence of a positive tension in the lap belt can be used as an implicit or indirect indicator the tongue and buckle have been latched together.

In general, the lower leg protection system 200 is capable of deploying an active element including an inflatable restraint to protect the lower body portions of a seated occupant 100 during a frontal collision. Referring specifically to FIG. 2, the lower leg protection system is configured as a low-mount air bag restraint system, which includes a crash management system 300. The crash management system 300 is shown schematically to include a crash sensor 302, a controller 304 and an optional proximity sensor 306. An added input to the controller 304 is the output signal generated by the tongue-buckle latch sensor 80. The crash management system 300 may also include a weight sensor 310 (mounted under the seat frame or under a lower seat cushion), which can also be used as another input to the controller 304. In the preferred mode of operation of the system, the lower restraint system is not activated if a) a weight (mass, that is, an occupant) of a certain level is sensed on the lower seat cushion, b) the seat belt buckle is latched and c) the proximity sensor 310 detects the occupant's lower legs near the air bag. A proximity sensor 310 might use a capacity proximity sensor (one using infrared or sonic waves).

The lower leg restraint system 200 includes an air bag deployment assembly 320, which is mounted in a lower portion of a dashboard (instrument panel) 18 or underneath the dashboard (instrument panel) 18. The assembly 320 is positioned and/or supported at the lower portions of the dashboard/instrument panel and is positioned in front of an occupant 100 seated on either the driver-side or the passenger-side seat of the vehicle. The air bag deployment assembly 320 includes a housing 322 and an air bag module 324 disposed within housing 322. Housing 322 includes or supports a front panel 326. A portion of the housing may extend within a cavity or aperture 328 formed in or below the dashboard/instrument panel 18. As is conventional, the air bag module 324 includes an air bag 334, which is in fluid communication with an inflator 330. The proximity sensor 310 is supported by the dashboard/instrument panel and positioned to sense the lower legs of the seated occupant.

In operation, when a frontal accident is sensed by activation of the crash sensor 302 the inflator 330 is activated, which causes the air bag to inflate providing an inflatable cushion to protect the lower extremities of the occupant 100. In this manner the air bag acts as a knee bolster. Depending on the specific design of the system 200, the front panel can be urged forward toward the knee (see phantom line in FIG. 2) or the lower leg of the occupant (by the inflating air bag) or simply moved out of the way of the inflating air bag (which cushions the lower leg). In the present invention if the controller 304 has also received the latch signal from the latch sensor 80 or a signal from proximity sensor 310, the controller 304 will not activate the lower restraint system 200.

Many changes and modifications in the above-described embodiment of the invention can, of course, be carried out without departing from the scope thereof. Accordingly, that scope is intended to be limited only by the scope of the appended claims.

1. An occupant safety restraint system comprising:
a first occupant protection system having at least one seat belt movable about the occupant:
a second occupant protection system comprising a lower leg protection system including a deployable knee bolster to protect at least a portion of the lower extremities of the occupant and
first means for deactivating the second occupant protection system based upon the operational state of the first occupant protection system.

2. The system as defined in claim 3 further including sensor means for generating a deactivation signal upon the occurrence of certain conditions.

3. The system as defined in claim 2 wherein the sensor means includes at least one of a first sensor configured to generate the deactivation signal on the latching of a seat belt tongue within a corresponding buckle and a proximity sensor configured to generate the deactivation signal when a portion of a lower leg of the occupant is sufficiently close to the knee bolster.

4. The system as defined in claim 1 wherein the first occupant protection system comprises a multi-point seat belt system.

5. The system as defined in claim 4 wherein the multi-seat belt system comprises a tongue latchable within a buckle.

6. The system as defined in claim 5 further including sensor means for generating a deactivation signal indicating one of a) the tongue is latched in the buckle and b) the tongue is not latched within the buckle.

7. The system as defined in claim 6 further including deactivation signal means responsive to the deactivation signal for deactivating the knee bolster.

8. The system as defined in claim 4 wherein the first means includes a lower leg proximity sensor for generating the deactivation signal.

9. The system as defined in claim 1 including a weight sensor for determining the presence of a seated occupant.
